(19) United States
(12) Patent Application Publication
(10) Pub. No.: US 2013/0138571 A1
(43) Pub. Date: May 30, 2013

(54) Systems and Protocols for Anonymous Mobile Payments with Personal Secure Devices

(71) Applicants: Apostol T. Vassilev, Austin, TX (US); Dimitar P. Jetchev, New York, NY (US); David Y. Jao, Waterloo (CA)

(72) Inventors: Apostol T. Vassilev, Austin, TX (US); Dimitar P. Jetchev, New York, NY (US); David Y. Jao, Waterloo (CA)

(21) Appl. No.: 12/238,229

(22) Filed: Sep. 25, 2008

Related U.S. Application Data
(60) Provisional application No. 60/995,431, filed on Sep. 26, 2007.

(51) Int. Cl. G06Q 20/38

(52) U.S. Cl. CPC G06Q 20/3829
USPC 705/71; 705/16

(57) ABSTRACT

Disclosed is a multi-purpose secure and anonymous payment system based on a variety of cryptographic confidentiality, authentication, and privacy methods. Users pay anonymously over the Internet using their mobile phones supported by the secure SIM card. The SIM cards do not reveal any personal payment information that is not directly necessary for the transaction to either the merchant or the bank. The system allows configuration of different cryptographic methods or hardware components to allow proper balancing of any specific implementation while maintaining strong security and privacy. It is resilient to connection breakdowns and allows users and merchants to recover from such disruptions without maintaining complex transaction states on the SIM card and without financial losses to any of the parties. The system and protocols can also be configured for electronic cash payments with smart cards or software agents on the Internet or at conventional merchant sale terminals.

### RELATED APPLICATION

The present application claims priority from the U.S. provisional patent application No. 60/995,431, filed Sep. 27, 2007 and entitled “Systems and Protocols for Anonymous Mobile Payments with Personal Secure Devices”, the disclosure of which is incorporated herein by reference.

### TECHNICAL FIELD

This invention relates to systems for electronic payments, and more specifically to secure and anonymous payment systems involving personal secure devices.

### BACKGROUND

Earlier patents claim methods and protocols based on blind signatures for promoting electronic cash (e-Cash) payments. One issue with these protocols is that in the classical setting, they require direct online communication between the customer P who wants to pay a merchant at his point-of-sale-terminal (POST), and the bank B that keeps his money. This requirement may present many challenges in real-life applications because of the heavy burden it puts on end-user devices with limited connectivity, such as many mobile hand-held platforms. The complexity of the existing protocols may prevent them from being used on devices with limited power or connectivity such as mobile phones and SIM cards.

In addition, the near simultaneity of the withdrawal event and the reimbursement event in these protocols may be used to correlate withdrawal amounts and reimbursement amounts. For instance, the merchant usually waits to receive the money from the bank before he dispenses the purchased goods or services. The existing algorithms guarantee that a third-party observer or the merchant cannot discover the identity of the customer. However, a law enforcement officer with access to the bank back-end can look at the incoming withdrawal requests and subsequent reimbursement request and try to correlate them by amount and time. In practice, using a simple technique like this may reveal the identity of the customer or at least narrow the possibilities down to a few choices. In this sense the existing e-Cash systems are not equivalent to real cash. In contrast, when a bank customer withdraws cash from her account at an ATM, all the bank knows is that she made a withdrawal of a certain amount at a certain date. The bank cannot tell how the customer spent the cash and the corresponding merchants that the customer dealt with cannot tell her identity.

The previous protocols mentioned above rely on a specific cryptographic technique called blinding to provide security and privacy. Moreover, some of them are designed to integrate the existing EMV financial protocols and as such rely on explicit communication between the client and the banking server at the time when the transaction takes place. Our proposed invention does not make use blinding and does not rely on such an explicit communication at the time of the transaction.

The general e-cash approach based on blinding subjects the customer to a privacy exposure due to the need to withdraw a transaction amount that typically is submitted to the merchant who in turn will submit it immediately back to the bank for reimbursement before releasing the goods or services.

Another approach is based on stored-value cards where a customer buys a card with nominal cash amount on it. He then uses it to pay anonymously to merchants utilizing existing financial transaction protocols. The card value may be replenished by a customer or the issuing institution. These protocols do not reveal the identity of the customer but allow the merchant to monitor the spending habits of a customer who uses the same card to pay for multiple small items. For example, a merchant may tell that a customer who bought milk one day, bought cereal the next day. Because of this tracing capability such payments are not equivalent to cash. Moreover, these methods rely on financial protocols that require any merchant reimbursement request to first be approved by a bank processing server before being submitted to the card for verification and update of the available debit amount. To accomplish this, the merchant must know a unique card identifier that it submits to the processing server for approval, along with the transaction amount. This unique card identifier can be used to monitor the user. The server sends back an approval which the terminal forwards to the card. This is exactly the opposite of what we propose in the protocols below. In addition, reloading of the cash amount on the card coupled with the explicit use of a card identifier exposes customer's privacy to more risk.

Finally, all earlier protocols that involve a financial back-end server and a smart card require complex financial transaction state management that renders them unusable for the unstable environment of the roaming mobile user we consider.

### SUMMARY

In this disclosure we define novel anonymous payment protocols without the need for live online communication between P and B or POST and B in order to complete a transaction of payment for goods or services.

A personal secure device is a tamper-resistant hardware token with a cryptographically-enabled CPU that is designed to withstand attacks on the information contained within. Smart cards and SIM cards for GSM mobile telephony are examples of such devices. There are many other types of personal secure devices which take different form-factors and use different technologies for ensuring tamper-resistance and security for the information contained within. Although we will refer predominantly to smart cards and SIM cards in the specifications below, our protocols can be used with other types of personal secure devices and corresponding systems can be configured easily.

For the purposes of our discussion we assume that a customer P is issued a personal secure device C from a mobile phone operator O or an issuing financial institution B. In practice, there is a direct link between the secure device and its owner: a physical link (the device is in the customer's possession and it might bear additional personal information such as name and picture) and a logical link (the person in possession of the device must know the PIN to use the services and data on it).

The present invention provides:
a multi-purpose flexible system for secure and anonymous payments that is configurable for usage in mobile payment applications, Internet payment applications or traditional merchant stores
systems and protocols which let users utilize their mobile Web-enabled phones with a SIM card or smart card to pay anonymously for goods or services without revealing any information not directly necessary for the transaction, as well as any information to which the terminal or the bank should not have access
systems and protocols that guarantee security, privacy, and protection against blackmailing using a variety of cryptographic confidentiality, authentication, and privacy methods
systems and protocols that allow the user to reload money for anonymous spending from her bank account onto her SIM card or smart card without any possibility for the bank or the merchants to monitor and link the subsequent spending transactions to the individual user
provide systems that allow configuration of different types of cryptographic methods or hardware components to allow proper balancing of the performance of any specific implementation by assigning heavier computational load to more capable components and reducing the load on the less-powerful SIM cards or smart cards while maintaining strong security and privacy guarantees
provide systems and protocols that are resilient to connection breakdowns and allow users and merchants to recover gracefully from such service disruptions without the need to maintain complex transaction state on the SIM card or the smart card and without financial losses to any of the parties involved

### BRIEF DESCRIPTION OF THE DRAWINGS

It will be appreciated that FIG. 1 is part of the description of a first preferred embodiment and that all other figures are part of the description of a second and third preferred embodiments.

FIG. 1 shows the system architecture of a preferred embodiment of a multi-purpose flexible system for anonymous payment, in accordance with the teachings of the present invention.

FIG. 2 shows the system architecture of an alternative embodiment of a multi-purpose flexible system for anonymous payment, in accordance with the teachings of the present invention.

FIG. 3 shows a simple point of sale terminal without network connectivity as an element of an alternative embodiment system, in accordance with the teachings of the present invention.

FIG. 4 shows the elements and steps required to reimburse merchants for goods and services sold to customers with smart cards in an alternative embodiment system with a point of sale terminal as shown in FIG. 2.

### DETAILED DESCRIPTION OF THE DRAWINGS

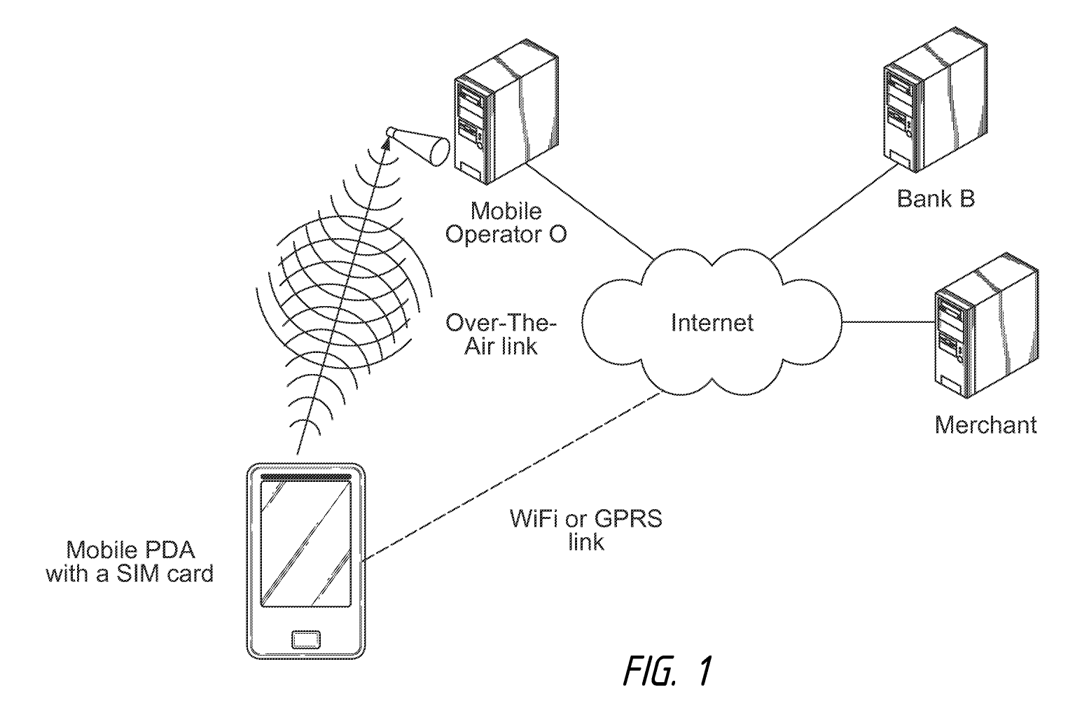

FIG. 1 illustrates an exemplary mobile payment system together with the prerequisites necessary for the integration and implementation of the protocol for secure and anonymous mobile payment as well as the protocol for merchant reimbursement. The customer with a mobile personal device assistant (PDA) signs up for mobile phone services with a mobile operator. The operator has full control on the customer's SIM card, i.e., it knows the cryptographic keys that allow lifecycle management of the SIM and the applications on it. The operator establishes a business relationship with a bank and rents the bank operational space on each customer SIM. The customer signs up for banking services with the bank. The bank passes to the operator a secure banking SIM application (applet) equipped with a bank signature key pair (the same for all customers) a unique shared secret key that allows the bank to communicate securely with the bank. The operator loads the applet onto the customer's SIM card (more precisely onto the bank's operational quota on the SIM) using Over-The-Air (OTA) protocols. The key is linked to the account of the customer with the bank. The private keys on the SIM are protected by a PIN, i.e., the customer must authenticate with her PIN to enable private key operations. The customer reloads cash to her SIM card on her mobile PDA or mobile phone from her bank account by pointing her browser to the bank's web portal. The customer browses the internet using her mobile PDA over WiFi or GPRS link. The customer points her browser to a merchant portal on the network that provides mobile web store functionality. The customer wants to pay the merchant's web store for goods or services with electronic cash on the SIM card on her PDA. The merchant collects the funds in a form usable within the legitimate financial system, represented by the bank. The customer remains anonymous to the merchant and the bank. The customer gets a receipt for the transaction.

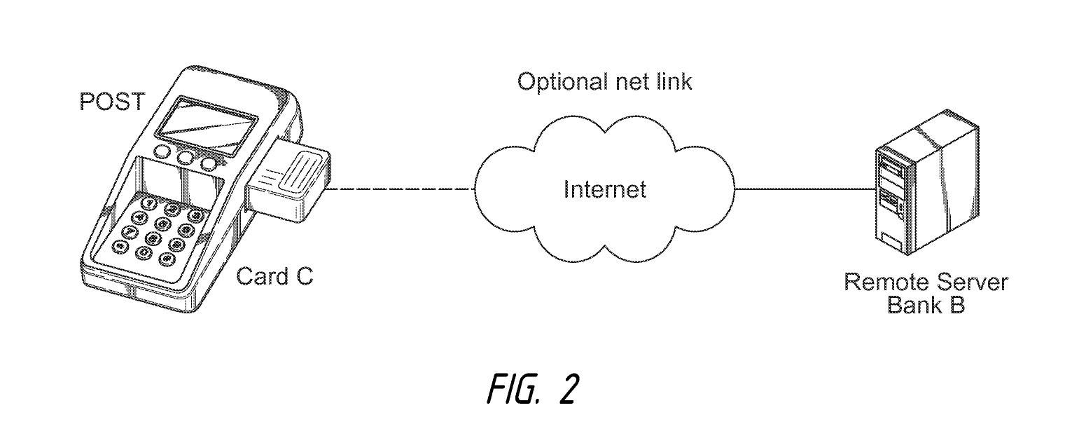

FIG. 2 illustrates an exemplary mobile payment system in which the PDA with the SIM card is replaced by a smart card. The customer signs up for banking services with the bank and deposits money into her account. The bank issues a payment card (smart card) to the customer. Each payment card is equipped with a bank signature key pair, the same for all customers. Upon card issuance, the bank server stores a unique shared secret key onto the card that allows the bank to communicate securely with the card. The key is linked to the account of the customer with the bank. The private keys are protected by a PIN, i.e., the customer must authenticate with her PIN to enable private key operations. The customer loads cash from a bank account to the smart card either at an ATM or via a secure channel on her computer. The customer wants to pay at a store or restaurant for goods or services with cash on the smart card. The merchant collects the funds in a form usable within the legitimate financial system, represented by the bank. The customer remains anonymous to the merchant and the bank. The customer gets a printed receipt for the transaction from the point-of-sale terminal. The merchant then gets reimbursed from the bank.

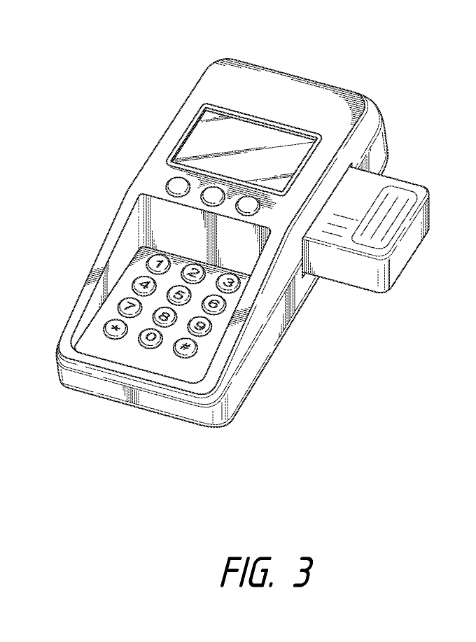

FIG. 3 illustrates a simple point-of-sale terminal without network connectivity as an element of an alternative embodiment system in which the electronic cash information is stored in a smart card instead of a SIM card of a mobile phone. In this case, after the payment is approved, the point-of-sale terminal prints a paper receipt for the client.

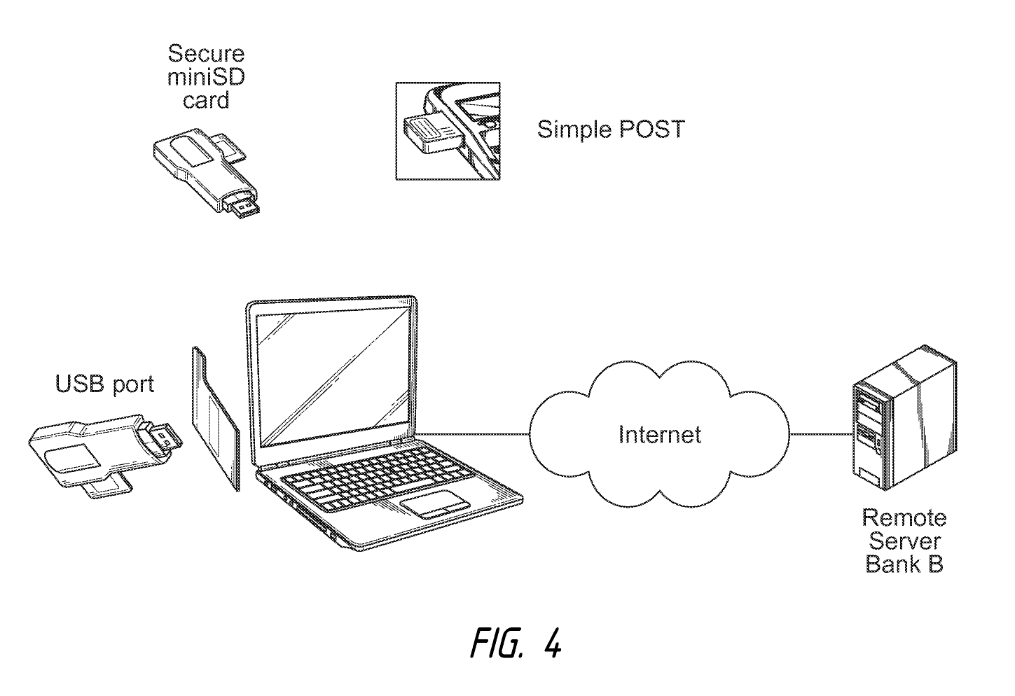

FIG. 4 illustrates the protocol for reimbursement for an embodiment in which the point-of-sale terminal (POST) is a simple iPod-like device with a display and a slot for card insertion. POST can store the transaction receipt onto a removable flash drive. This device may be used by roaming merchants in locations where there is no reliable network connectivity. The device records customer transaction components (see the simple and enhanced payment protocols below) onto its secure miniSD plug-in. The secure miniSD device has a secure CPU bundled with the mass-storage controller. The secure CPU allows the miniSD device to recognize that it is plugged into a legitimate POST and configures the mass-storage partition with Read/Write permissions. This allows POST to store the transaction components onto the miniSD mass-storage media. The components for each transaction may be organized in some appropriate way into the file system of the miniSD device in order to simplify their discovery and processing during reimbursement. To get reimbursed, the merchant removes the miniSD device from the POST and inserts it into a standard USB adapter. Then, the merchant plugs the adapter into a standard USB port of a PC and starts a special end-user software application for processing the transactions. The secure miniSD device recognizes upon connecting and powering-on that it is not plugged into a legitimate POST device and makes the mass-storage partition read-only. This prevents malicious software on the PC from being able to damage the data on the flash disk and thus inflict a financial loss on the merchant. The merchant then utilizes the software to submit the transactions to the bank and get paid.

### DESCRIPTION OF THE INVENTION

A System for Anonymous Payments with Personal Secure Devices

The architecture of the preferred embodiment mobile anonymous payment system is shown in.

### Typical Use Case

P browses the Internet using her mobile PDA over the WiFi or GPRS link. P points her browser to a merchant portal on the network that provides mobile web store functionality. P wants to pay the merchant's web store POST for goods or services with the SIM card on her PDA. POST wants to collect the funds in a form usable within the legitimate financial system, represented by a bank B. P wants to remain anonymous to POST and B. P must get a receipt for the transaction, which the system must be able to provide.

### Funds Reload Use Case

P wants to reload cash to her SIM card from her account at B from her mobile PDA or phone and pointing her browser at the bank's mobile Web portal.

### Alternative System for Anonymous Payments

The architecture of an alternative embodiment of the payment system with a traditional merchant store with a POST is shown in .

### Typical Use Case

P wants to pay the merchant at this portable POST for goods or services with a smart card C. POST wants to collect the funds in a form usable within the legitimate financial system, represented by a bank B. P wants to remain anonymous to POST and B. P must get a paper receipt for the transaction, which the system must be able to provide.

### Funds Reload Use Case

P wants to reload cash to her smart card C from her account at B at a bank ATM or sitting at her computer and pointing her browser at the bank's Web portal.

### Secure Protocols for Anonymous Payments

### Prerequisites for Anonymous Payments With a SIM Card (Preferred Embodiment)

P signs up for mobile phone services with an operator O. O has full control on P's SIM, i.e., it knows the cryptographic keys that allow lifecycle management of the SIM and the applications on it. The operator O establishes a business relationship with a bank B and O rents B operational space on each customer SIM. P signs up for banking services with B. B passes to O a secure banking SIM application (applet) APP_{B} equipped with a bank signature key pair (the same for all customers) a unique shared secret key K_{c} that allows B to communicate securely with APP_{B}. O loads APP_{B} onto P's SIM card (more precisely onto B's operational quota on the SIM) using well-known secure Over-The-Air (OTA) protocols. The key K_{c} is linked to the account of P with B. The private keys on the SIM are protected by a PIN, i.e., the customer must authenticate with his/her PIN to enable private key operations.

P loads a nominal amount of cash l on APP_{B} using a secure OTA based on the shared secret K_{c}, which B debits from P's account and deposits into a special pool account A (see the protocol for cash reload below). The banking server B generates a random customer debit lease identifier iₗ and associates the amount l with it. The banking server also generates a cryptographic key pair Kᵢ and associates with the debit lease. Simultaneously the banking server writes iₗ and Kᵢ to the card APP_{B}. Thus, A contains money from many customers who have been issued the payment application APP_{B} for their SIM cards; the total amount is subdivided logically into debit leases of capacity l, each identified by the corresponding iₗ and the key pair The pool account A and APP_{B} initially have the same values for l and iₗ. The bank server does not store any information link between the original customer account and iₗ or Therefore, one cannot trace the identity of the customer from iₗ or Kᵢ.

### Prerequisites for Anonymous Payments With a Smart Card

P signs up for banking services with B and deposits money into his/her account. B issues a payment card (smart card) C to P. Each payment card C is equipped with a bank signature key pair, the same for all customers. Upon card issuance, the server B stores a unique shared secret key K_{c} onto C that allows B to communicate securely with C. The key K_{c} is linked to the account of P with B. The private keys are protected by a PIN, i.e., the customer must authenticate with his/her PIN to enable private key operations.

P loads a nominal amount of cash l on C at an ATM or over a secure channel on his/her computer, which B debits from P's account and deposits into a special pool account A (see the protocol for cash reload below). The banking server B generates a random customer debit lease identifier iₗ and associates the amount l with it. The banking server also generates a cryptographic key pair Kᵢ and associates with the debit lease. Simultaneously the banking server writes iₗ and Kᵢ to the card C. This operation typically takes place at an ATM or another secure bank facility. Thus, A contains money from many customers who have been issued payment cards; the total amount is subdivided logically into debit leases of capacity l, each identified by the corresponding iₗ and the key pair Kᵢ. The pool account A and the card C initially have the same values for l and iₗ. The bank server does not store any information link between the original customer account and iₗ or Kᵢ. Therefore, one cannot trace the identity of the customer from iₗ or Kᵢ.

### Protocol for Mobile Anonymous Payment With a SIM Card

We use RSA notation. Let n=pq be the product of two large primes. Let e be the public exponent and d be the corresponding private exponent of the bank key pair. Let hᵢ=gu be the product of another two large primes, such that hᵢ is the modulus corresponding to the key pair Kᵢ, x is the public exponent, and y is the private exponent associated to the lease iₗ. Let H: {0, 1}*→{0, 1}^{k} be a one-way secure, collision-free hash function (e.g., SHA-256 for k=256) and let al lb denote the concatenation of the binary representations of two strings a and b. Note that in this case POST is simply an end-user application executing into the memory of P's mobile phone, serving as a proxy to the merchant's web store virtual sale terminal, and capable of communicating with the SIM card and APP_{B} on it.

The protocol consists of the following steps:
1. POST prompts the user for PIN and sends APP_{B} the PIN value along with a request t to spend an amount m. Note here that t is a message containing the original spending amount m, merchant identification, transaction identification, time-stamp, etc.
2. APP_{B} verifies the PIN. If the PIN is incorrect or m>1, APP_{B} generates an error and quits. Else, APP_{B} updates l=l−m.
3. APP_{B} generates a random r_{c}, and computes t_{H}=H(t∥r_{c}∥iₗ).
4. APP_{B} computes tᵣ=.H(t∥r_{c}).
5. APP_{B} computes t*=(t_{H})^{v} mod hᵢ.
6. APP_{B} computes t^{˜}=(tᵣ)^{d} mod n.
7. APP_{B} pads iₗwith random padding and computes iₗ⁺=iₗ^{e} mod n.
8. APP_{B} computes t⁺=t∥r_{c}∥t^{˜}∥iₗ⁺∥t*
9. APP_{B} sends t⁺ to POST.
10. POST stores a copy of t⁺ onto P's mobile device (phone or PDA) as a receipt for payment.
11. POST extracts r_{c} and t^{˜} from t⁺ and computes t̂ᵣ=.H(t∥r_{c})
12. POST computes tᵣ=(t^{˜})^{e} mod n.
13. If tᵣ≠t̂ᵣ POST generates an error and stops.
14. POST stores t⁺ for later reimbursement from B and releases the goods or services to P. POST also uses the stored copy of t⁺ to prevent dishonest customers from replaying old payment receipts.

Note: We can use a symmetric key Kᵢ instead of the asymmetric key pair for the debit lease account. In this case t*=E_{K}(t_{H}) is the result of the symmetric encryption of iₗ with the key Kᵢ. In practice, one can use AES or TripleDES with the key Kᵢ to perform this operation.

Note: We use the random factor r_{c} to mark each payment receipt r in order to facilitate undeniable tracing of past transactions by B and POST.

Note: The user may also be prompted to enter the payment amount m along with her PIN in order to ensure that no amount is withdrawn from the SIM without the explicit consent of P. In addition, the user may also be asked to provide the answer to a difficult-to-solve-by-a-computer puzzle along with the PIN in order to ensure that each payment is a direct result from the human-to-card interaction between P and APP_{B}. This would eliminate attacks on the PIN by malicious key-logging software tools and further enhance the protection of the user.

### Protocol for Anonymous Payment With a SIM Card Using ECC-Based Signatures (Preferred Embodiment)

Let q be a prime power of size 160 bits and let E be an elliptic curve over F_{q}, such that #E(F_{q}) is prime. Let Q be a generator for E(F_{q}) and N be the order of E(F_{q}). Consider a cryptographic pairing e: E(F_{q})×E(F_{q})→G, where G is some finite group (e.g., Weil pairing or Tate pairing). Each debit lease identifier iₗ will have a pair of a public and a private key. The private key is a random multiplier xᵢ in the interval [1 . . . N−1], whereas the public key is the point Qᵢ=xᵢQ. These keys are generated by the banking server and are written to the SIM card application APP_{B}. Let H: {0, 1}*→E(F_{q}) be a secure one-way collision-resistant hash function (e.g., obtained from SHA-1). Let |s| denote the length of a binary string s in bits.

For the bank key pair (used for encryption of the deposit lease identifiers and for signature verification at the POST terminal) we let d be the private key of B (a multiplier in [1 . . . N−1]) and Q_{pub}=dQ be the corresponding public key. Both d and Q_{pub} are initially written to the SIM application APP_{B}.

Note that in this case POST is simply an end-user application executing into the memory of P's mobile phone, serving as a proxy to the merchant's web store virtual sale terminal, and capable of communicating with the SIM card and APP_{B} on it.

The mobile anonymous payment protocol for P consists of the following steps:
1. POST sends APP_{B} a request for t to spend an amount m. Here, t is a binary message containing information about the spending amount m, the merchant identification, transaction identification, time-stamp, etc
2. If m>l then APP_{B} generates an error and exits; else, APP_{B} updates l=l−m.
3. APP_{B} generates a random bit string r_{c} (of some specified length) and computes the point
4. P_{H}=H(t∥r_{c}∥iₗ) and the signature sig=xi P_{H}.
5. APP_{B} pads iₗ with a random padding, chooses a random multiplier k in [1 . . . N−1] and computes iₗ⁺=(kQ, W(iₗ)+kdQ), where W is a standard embedding of plaintext binary messages into points on the elliptic curve
6. APP_{B} computes Pᵣ=H(t∥r_{c}) and P^{˜}=dPᵣ
7. APP_{B} computes t⁺=t∥r_{c}∥P^{˜}∥iₗ⁺∥sig and sends it to POST
8. POST stores a copy of t⁺ onto P's mobile device (phone or PDA) as a receipt for payment
9. POST extracts t, r_{c} and P^{˜} from t⁺ and computes P̂=H(t∥r_{c})
10. POST computes eₗ=e(Q, P^{˜}) and e₂=e(Q_{pub}, P̂)
11. If eₗ≠e₂ POST generates an error and stops.
12. POST stores t⁺ for later reimbursement from B and releases the goods or services to P. POST also uses the stored copy of t⁺ to prevent dishonest customers from replaying old payment receipts.

Note: We can use the standard EC-DSA algorithm (with the same public key Q_{pub} and private key d) for the POST signature verification, instead of the pairing-based signature. This would simplify the verification (since no pairings are involved), but would make the signature longer.

Note: The transmitted message t⁺ containing the original message t, the signature sig and the RSA encryption of the padded debit lease identification number could still be shortened by using ECC-based encryption (e.g., ECC-based ElGamal) instead of RSA encryption. Then
   |t⁺|=|t|+320; otherwise,
   |t⁺|=|t|+160 (signature length)+1024 (for the RSA encryption of the lease identifier).

### Protocol for Anonymous Payment With a Smart Card at a POST

We use RSA notation. Let n=pq be the product of two large primes. Let e be the public exponent and d be the corresponding private exponent. Let hₗ=gu be the product of another two large primes, such that hᵢ is the modulus corresponding to the key pair Kᵢ, x is the public exponent, and y is the private exponent. Let H: {0, 1}*→{0, 1}^{k} be a one-way secure, collision-free hash function and let a∥b denote the concatenation of the binary representations of the strings a and b.

The protocol consists of the following steps:
1. POST prompts the user for PIN and sends C the PIN value along with a request t to spend an amount m. Note here that t is a message containing the original spending amount m, merchant identification, transaction identification, time-stamp, etc
2. C verifies the PIN. If the PIN is incorrect or m>l, C generates an error and quits. Else, C updates l=l−m
3. C generates a random r_{c}, and computes t_{H}=H(t∥r_{c}∥iₗ)
4. C computes tᵣ=.H(t∥r_{c})
5. C computes t*=(t_{H})^{v} mod hᵢ
6. C computes t^{˜}=(tᵣ)^{d} mod n
7. C pads iₗ with random padding and computes iₗ⁺=iₗ^{e} mod n
8. C computes t⁺=t∥r_{c}∥t^{˜}∥iₗ⁺∥t*
9. C sends t⁺ to POST
10. POST stores a copy of t⁺ onto P's computer as a receipt for payment. If POST is a simple mobile terminal (see below), it prints a paper receipt for P
11. POST extracts r_{c} and r from t^{˜} and computes t̂ᵣ=.H(t∥r_{c})
12. POST computes tᵣ=(t^{˜})^{x} mod n
13. If tᵣ≈t̂ᵣ POST generates an error and stops
14. POST stores t⁺ for later reimbursement from B and releases the goods or services to P. POST also uses the stored copy of t⁺ to prevent dishonest customers from replaying old payment receipts

### Protocol for Reimbursement of POST by B

The protocol consists of the following steps:
1. POST sends t⁺ to B
2. B extracts iₗ⁺ from t⁺ and computes iₗ=(iₗ⁺)^{d} mod n. Note that B removes the random padding previously added to iₗ by C or APP_{B} from the decrypted result.
3. If iₗ does not exists in A, B generates an error and stops
4. B extracts t∥r_{c} from t⁺ and computes t̂_{H}=H(t∥r_{c}∥iₗ)
5. B extracts t* from t⁺ and computes t_{H}=(t*)^{x} mod hₗ
6. If t̂_{H} ≈t_{H} or m>l, B generates an error and stops. Else, it updates l=l−m for the corresponding lease iₗ
7. B records the transaction information contained in t and r_{c} to prevent replay of old messages by dishonest merchants

Note: In the alternative case of a symmetric encryption key Kᵢ the back-end server B computes t_{H}=E_{K}⁻¹(t*).

### Protocol for Reimbursement of POST by B Using ECC-Based Signatures (Preferred Embodiment)

1. POST sends t⁺ to B
2. B extracts iₗ⁺ from t⁺, computes W⁻¹(iₗ⁺−d(kQ)) and removes the padding added by APP_{B} to obtain iₗ. Here, W is the same standard embedding of plaintext messages into points on the elliptic curve as in Step 4 of the ECC-based payment protocol.
3. If iₗ is not a valid debit lease identification number in the pool account A, the bank generates an error and exits
4. B extracts t and sig from t⁺ and computes P_{H}=H(t∥r_{c}∥iₗ)
5. The bank server B computes the two pairing values e(P_{H},Qᵢ) and e(sig, Q)
6. If e(P_{H}, Qᵢ)=e(sig, Q) and l>m, B reimburses POST and updates l=l−m; otherwise, it generates an error and exits
7. B records the transaction information contained in t and r_{c} to prevent replay of old messages

### Protocols for Protecting P From Blackmailing During Anonymous Payments (Preferred Embodiment)

The anonymous payment protocols need to protect users from blackmailing [6]. To accomplish this we introduce a Panic-PIN on the SIM application APP_{B} or the card C. The Panic-PIN is an alternative PIN that enables private key operations just like with the other normal PIN. However, the card or the SIM application knows which PIN was used and can mark this condition in a flag f; f=0 indicates normal PIN and f=1 indicates Panic-PIN. Then, we define t_{H}=H(t∥r_{c}∥iₗ∥f). The server B upon reimbursement computes t̂_{H}=H(t∥r_{c}∥iₗ∥0).

Note that signature check will fail if f=1 was used on the card. Note also that the value off is not sent explicitly in the protocol and since the value of the public exponent x that corresponds to hₗ is not known to a third party, an observer of the protocol cannot determine the value off even if the bank key with modulus n is broken. The server B can detect the blackmail condition and take appropriate actions. This provides strong protection of P against blackmail attempts.

Hint for practical implementations: the particular order in which f is added to the bit-stream used to calculate t_{H} is not important, as long as both sides (B and C/APP_{B}) know it.

### Protocol for Cash Reload on C by B

The protocol consists of the following steps:
1. P authenticates to B and B establishes a secure channel with C using well-known challenge/response protocols based on the shared secret K_{c}
2. B generates new values for iₗ and Kᵢ and associates them with the new spending amount l transferred from P's account into A
3. B sends C the new values for l, iₗ, and Kᵢ
4. C responds with the remaining old balance on the card l^{old} and the old lease identifier iₗ^{old}
5. B transfers the amount from the lease iₗ^{old} into the new lease l
6. B sends a confirmation to C
7. C sets l=l+l^{old} and updates iₗ
8. C sends a confirmation to B

### Protocols for Cash Reload on Mobile APP_{B} (Preferred Embodiment)

The protocol consist of the following steps:
1. P authenticates to B and B establishes a secure channel with APP_{B} using well-known OTA challenge/response protocols based on the shared secret K_{c}
2. B generates new values for iₗ and Kᵢ and associates them with the new spending amount l transferred from P's account into A
3. B sends APP_{B} the new values for l, iₗ, and Kᵢ
4. APP_{B} responds with the remaining old balance on the card l^{old} and the old lease identifier iₗ^{old}
5. B transfers the amount from the old lease iₗ^{old} into the new lease l
6. B sends confirmation to APP_{B}
7. APP_{B} sets l=l+l^{old} and updates
8. APP_{B} sends confirmation to B

### Privacy and Security Advantages of the Financial Transaction Schema Implemented by the Payment, Reimbursement, and Cash Reload Protocols

There is no way for B or POST to identify any customer-specific information that links the person buying the goods or services to the financial transaction recorded between POST and B. At most, B can compile a database of leases iₗ and associated customer accounts, in contravention of the protocol, and thereby link customers to merchants during the reimbursement phase of the protocol. However, a similar attack is also possible with real cash, in which a bank records the serial numbers of banknotes that are deposited and withdrawn from the bank.

Even if an adversarial customer or a merchant factors n or uses alternative techniques (e.g. differential power analysis) to gain knowledge of d, the hacker would find out iₗ but he will not be able to discover the identity of the customer from it nor abuse her account. Recall that by setup, there is no link between iₗ and the identity of the customer of B. To drain a customer account, the hacker would have to gain physical possession of a customer card C and hack the PIN because the PIN has a limited number of tries before it is blocked. This is hard to achieve. Therefore the total gain of the hacker is that he will be able to tell the different debit lease identifiers iₗ but this is not enough to give him actionable information to drain money from A (The attacker can also forge payments from iₗ and thereby defraud merchants, but the customer's funds are not at risk. This is an acceptable level of risk for the scenario where the private key d is compromised.)

A customer does not have to worry about a merchant recording any identifiable information relating purchases to her card C. Indeed, because of the random padding used in computing i*ₗ and iₗ⁺, the POST cannot relate two subsequent transactions with the same card C.

The blackmail protection feature introduced with the help of a second Panic-PIN allows customer protection. The blackmailer may hijack the paying receipt t⁺ before it gets submitted to POST in order to use it for his own gain. However, when submitted to the bank B, it will detect the circumstances of the withdrawal and will warn POST to reject the transaction.

Paying electronically in this way is equivalent to paying by cash from a privacy perspective.

### Practical Advantages of the Financial Transaction Schema by the Payment, Reimbursement, and Cash Reload Protocols

There is no need for a live link between C/APP_{B} and B at the time when P pays for goods and services. This improves the robustness of the protocols for real-life applications. In particular, it eliminates the need to maintain complex transaction state on C/APP_{B} and B. This is very important for the practical applications we envision: it is not reasonable to assume that the WiFi or GPRS connection between P's mobile phone/PDA to the Internet will be stable and available when the customer moves from one area to another, often with high speed. In our framework, the money receipt t⁺ is stored on the phone, PDA, or PC and the customer can easily resubmit it to POST when the network is re-established. Thus, the customer does not have to worry about losing the money withdrawn from the card.

Another important advantage our approach offers allows the complexity and cost of POST to be reduced significantly. For example, POST can be a simple iPod-like device with a display and a slot for card insertion. POST can store r onto a removable flash drive. This device may be used by roaming merchants in locations where there is no reliable network connectivity. The device records customer transaction components (see the simple and enhanced payment protocols below) onto its secure miniSD plug-in. The secure miniSD device has a secure CPU bundled with the mass-storage controller. The secure CPU allows the miniSD device to recognize that it is plugged into a legitimate POST and configures the mass-storage partition with Read/Write permissions. This allows POST to store the transaction components onto the miniSD mass-storage media. The components for each transaction may be organized in some appropriate way into the file system of the miniSD device in order to simplify their discovery and processing during reimbursement.

To get reimbursed, the merchant removes the miniSD device from the POST and inserts it into a standard USB adapter (see). Then, the merchant plugs the adapter into a standard USB port of a PC and starts a special end-user software program SW for processing the transactions. The secure miniSD device recognizes upon connecting and powering-on that it is not plugged into a legitimate POST device and makes the mass-storage partition Read-only. This prevents malicious software on the PC from being able to damage the data on the flash disk and thus inflict a financial loss on the merchant. The merchant then utilizes SW to submit the transactions to B and get paid.

Because t⁺ is marked with the ID of the merchant, there is no real incentive for a thief to steal the flash device with non-reimbursed transactions. Similarly, if a customer looses C, it is a cash loss for him/her but another person who finds it cannot make use of the cash because of the PIN protection. This provides an incentive for B to use this model of payment because B will get to use free unclaimed money in A. Therefore, our framework offers a unique combination of technology and financial incentives that allow all involved parties to benefit.

Note that in cases when B is out of the loop when POST and C complete the transaction, B typically provides out-of-band blanket financial assurance to POST that it will honor the digital receipts t⁺ produced by the payment protocol, usually contained in the affiliation contract that POST and B sign.

A real-life example is that a Sherpa equipped with a simple and small portable terminal can sell water or food to mountain climbers on a base camp to Mount Everest without the climbers having to need real cash and to worry about losing it or being robbed by other dishonest climbers. It is practically impossible to enable a real-time link between the POST and B or C and B from such a remote location and so this new protocol allows the transaction to take place in the absence of such a link. The flash drive is actually stronger to resist the elements than banknotes, so the Sherpa can safely get reimbursed later when he reaches his town.

The payment framework we have defined allows flexibility in the choice of cryptographic algorithms while preserving the overall strength of security and privacy protection. This allows specific implementations to experiment and find the right computational load balance for a specific hardware system configuration. Thus, the overall performance of real-life implementations of the payment framework on systems utilizing computationally weak personal secure devices, such as smart cards, may be improved.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

We claim:

1. A multi-purpose flexible payment processing system comprising one or more banks, one or more merchants with one or more sale terminals, and one or more users with computing devices interacting with a proxy application provided by a bank, communicating over a network using a variety of cryptographic confidentiality, authentication, and privacy methods to pay anonymously for goods and services on the said network using secure protocols.

2. The system of claim 1, wherein said proxy application and the said protocols for communication with the said user, merchant, and bank parties involved do not reveal any information to the said user, merchant, and bank parties involved which is not directly necessary for the transaction or any information to which the said user, merchant, and bank parties involved should not have access.

3. The system of claim 1, wherein said security and privacy guarantees are provided through multi-layer cryptographic protection enabled by utilization of independent cryptographic keys for each layer.

4. The system of claim 1, wherein the network is the Internet and the merchant includes a merchant Web site offering goods or services for sale over said Internet.

5. The system of claim 4, wherein said users with said computing device includes a Web browser and a software agent capable of connecting the browser to the proxy application and thus allowing the user, the Web browser and the proxy application to interact with the said merchant web site.

6. The system of claim 1, wherein the proxy application is an embedded applet running on a personal secure device.

7. The system of claim 6, wherein the computing device is a mobile phone and the personal secure device is a SIM card.

8. The system of claim 7, wherein a mobile phone operator can load SIM software applications belonging to the said bank to the said SIM card on the said user mobile phone using over-the-air protocols or conventional protocols over fixed network lines.

9. The system of claim 6, wherein said communication over the said network can be unavailable but the said system can continue to operate normally without the need to maintain complex transaction state on the said personal secure device and without financial losses to any of the said user, merchant, and bank parties involved.

10. The system of claim 6, wherein said system allows the configuration of different types of said cryptographic methods, including cryptographic methods that are more resilient to differential power analysis attacks on the cryptographic keys stored on the said personal secure device and yielding short signatures that are beneficial for communication constrained devices such as the said personal secure device, or hardware components to allow proper balancing of the performance of any specific implementation by assigning heavier computational load to more capable components and reducing the load on the less-powerful said personal secure device while maintaining strong security and privacy guarantees.

11. The system of claim 1, wherein said bank provisions an anonymous debit lease account for each said proxy application.

12. The system of claim 11, where said protocols do not provide any traceability of said user spending by the said merchant or the said bank thereby protecting the said user's privacy.

13. The system of claim 11, wherein said bank allows the said user to securely transfer money using the said user's computing device connected to the said network from the said user's personal account with the said bank to a new said anonymous debit lease account and update the spending limit on the said user's anonymous debit lease account; the said bank does not record any said user's identifiable information that may link the said user's personal account with the said user's new anonymous debit lease account.

14. The system of claim 1, wherein said proxy application generates a record of electronic payment that contains a merchant identifier thereby reducing the financial incentive on thieves to steal the record.

15. The system of claim 14, wherein said record of electronic payment is stored on the said user's computing device and/or said merchants terminal and allows the said merchant to verify the said record's integrity and authenticity before releasing the goods or services to the said user.

16. The system of claim 14, wherein said record of electronic payment allows traceability of merchant reimbursement and prevents same said record from being used multiple times.

17. The system of claim 14, wherein said protocol protects said users from blackmailing and allows said records of electronic payments to be marked by the said user as blackmail in a way completely invisible to anyone but the said user and the said bank, thereby protecting the said user from harm while making the said electronic payment record unusable for the blackmailer.

18. The system of claim 1, wherein said network is the conventional financial network for credit card payments and said merchant includes a conventional or online store with a sale terminal connected to the said financial network or any other network, or a said terminal temporarily disconnected from any network, or a said terminal disconnected from the network utilizing a data store which is later connected to a network.

19. A method comprising one or more banks, one or more merchants with one or more sale terminals, and one or more users with computing devices interacting with a proxy application provided by a bank, transmitting electronic payments over a network in a secure, confidential, and anonymous manner by:
having the proxy application maintain an encrypted account balance via cryptographic keys provisioned by the bank
authenticating cash transfers with digital signatures generated from said cryptographic keys
identifying cash reloads with randomly generated lease identifiers that contain no stored information linking lease identifiers to customer accounts

20. The method of claim 19, wherein the proxy application is an embedded applet running on a personal secure device.

21. The method of claim 20, wherein said transmissions over the said network can be disabled but the said system can continue to operate normally without the need to maintain complex transaction state on the said personal secure device and without financial losses to any of the said user, merchant, and bank parties involved.

22. The method of claim 19, wherein said network is the Internet and said merchant includes a merchant Web site offering goods or services for sale over said Internet.

23. The method of claim 22, wherein said users with said computing device includes a Web browser and a software agent capable of connecting the browser to the proxy application and thus allowing the user, the Web browser and the proxy application to interact with the said merchant web site.

24. The method of claim 19, wherein said network is the conventional financial network for credit card payments and said merchant includes a conventional or online store with a sale terminal connected to the said financial network or any other network, or a said terminal temporarily disconnected from any network, or a said terminal disconnected from the network utilizing a data store which is later connected to a network.
